(19) United States
(12) Patent Application Publication
(10) Pub. No.: US 2021/0046916 A1
(43) Pub. Date: Feb. 18, 2021

(54) Remote Braking Assembly

(71) Applicant: Willie Patterson, Houston, TX (US)

(72) Inventor: Willie Patterson, Houston, TX (US)

(21) Appl. No.: 16/542,003

(22) Filed: Aug. 15, 2019

(51) Int. Cl. B60T 17/20; B60T 7/10

(52) U.S. Cl. CPC B60T 17/20; B60T 7/10

(57) ABSTRACT

A remote braking assembly for facilitating a passenger to apply brakes in a vehicle includes a roller unit that is coupled to a floorboard of a vehicle. The roller unit is aligned with a brake pedal of the vehicle. A handle is movably positioned within the vehicle. The handle is directed toward a passenger seat of the vehicle such that the handle is accessible to a passenger in the vehicle. A cable is coupled between the handle and the brake pedal of the vehicle. The cable draws the brake pedal into a depressed position when the handle is urged into a braking position. In this way the passenger can remotely apply the brakes of the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to braking devices and more particularly pertains to a new braking device for facilitating a passenger to apply brakes in a vehicle.

### (2) Description of Related Art Including Information Disclosed Under 37 CFR 1.97 and 1.98

The prior art relates to braking devices.

### BRIEF SUMMARY OF THE INVENTION

An embodiment of the disclosure meets the needs presented above by generally comprising a roller unit that is coupled to a floorboard of a vehicle. The roller unit is aligned with a brake pedal of the vehicle. A handle is movably positioned within the vehicle. The handle is directed toward a passenger seat of the vehicle such that the handle is accessible to a passenger in the vehicle. A cable is coupled between the handle and the brake pedal of the vehicle. The cable draws the brake pedal into a depressed position when the handle is urged into a braking position. In this way the passenger can remotely apply the brakes of the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a remote braking assembly according to an embodiment of the disclosure.

FIG. 2 is a perspective in-use view of an embodiment of the disclosure.

FIG. 3 is a phantom view of a roller unit and a brake pedal of an embodiment of the disclosure.

FIG. 4 is an interior perspective view of an embodiment of the disclosure.

### DETAILED DESCRIPTION OF THE INVENTION

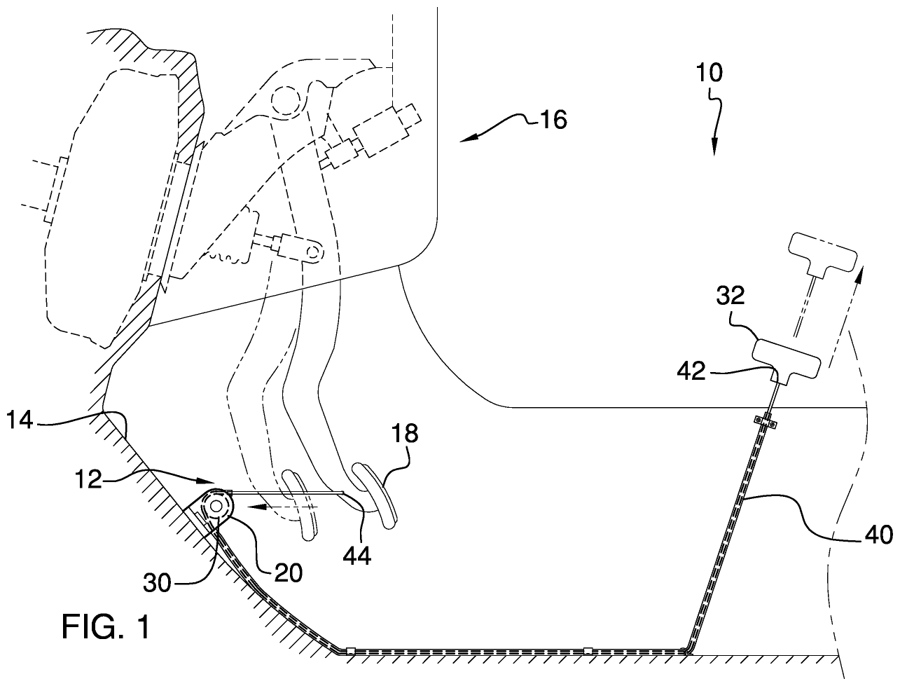

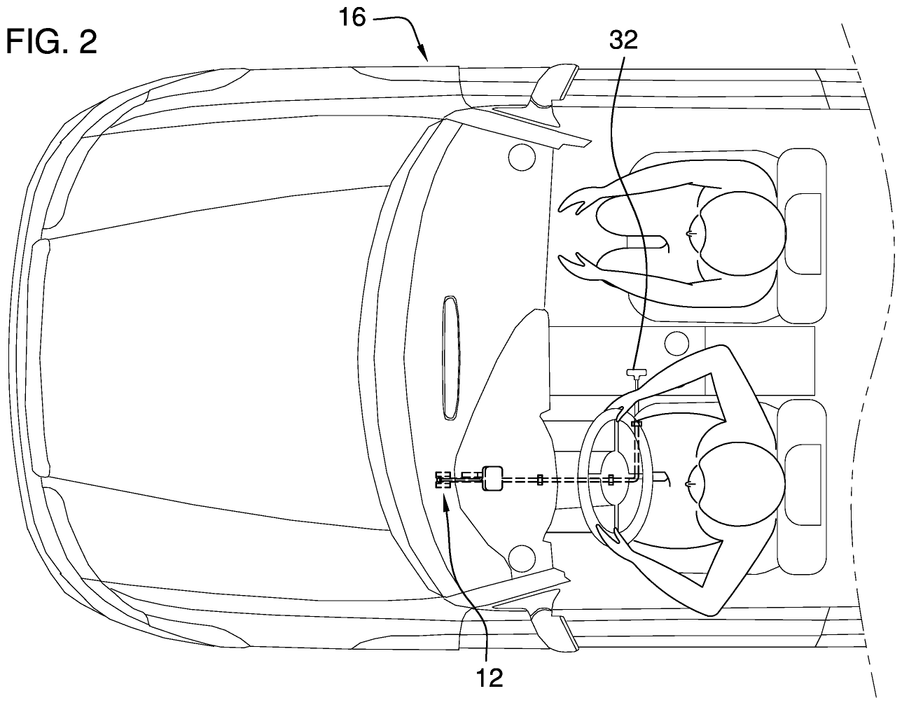

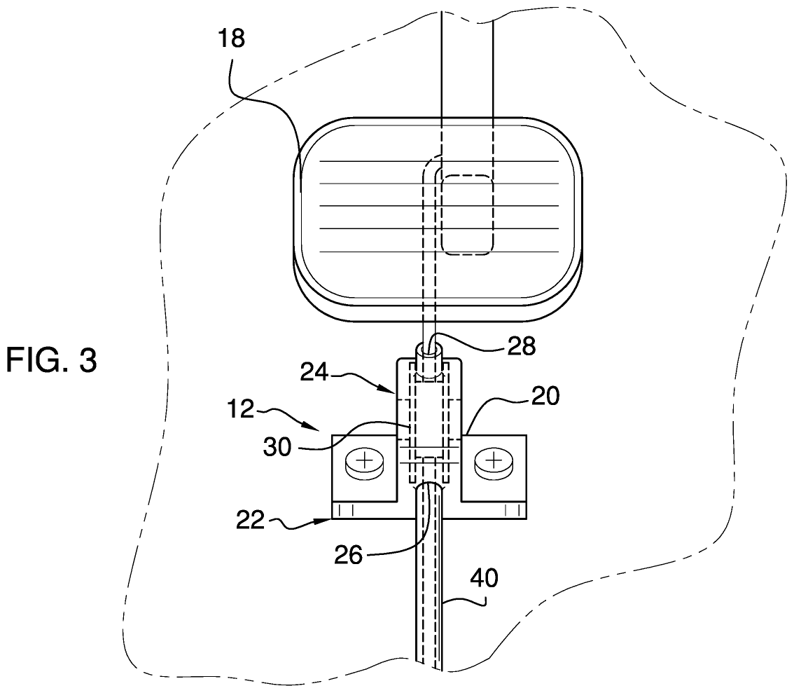

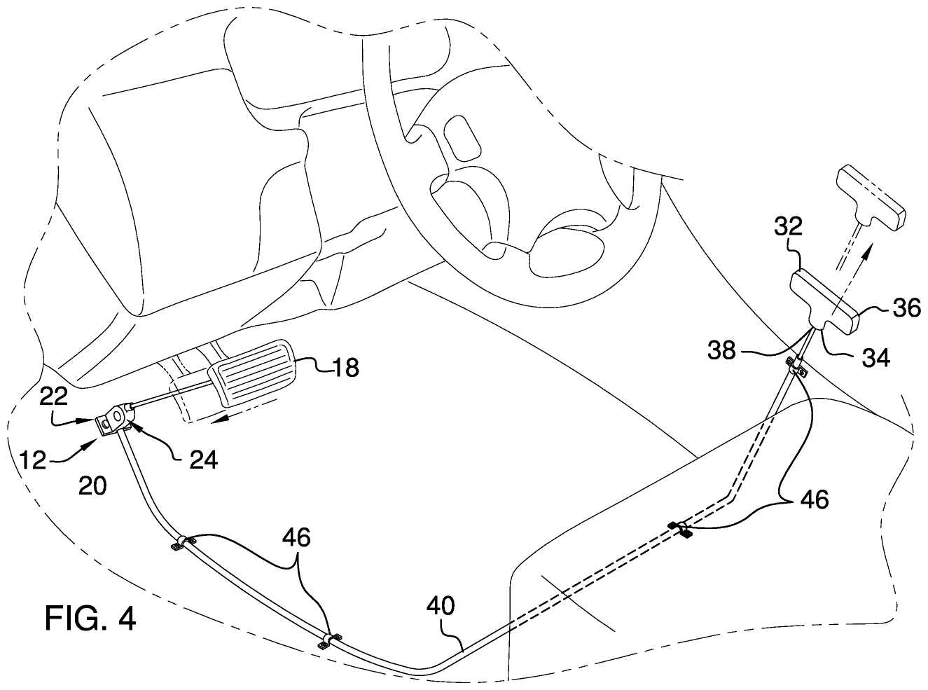

With reference now to the drawings, and in particular to FIGS. 1 through 4 thereof, a new braking devices embodying the principles and concepts of an embodiment of the disclosure and generally designated by the reference numeral 10 will be described.

As best illustrated in FIGS. 1 through 4, the remote braking assembly 10 generally comprises a roller unit 12 that is coupled to a floorboard 14 of a vehicle 16. The vehicle 16 may be any motor vehicle that is driven on public roadways. Additionally, the roller unit 12 is aligned with a brake pedal 18 of the vehicle 16. The roller unit 12 comprises a bracket 20 that has a basal portion 22 and an upright portion 24. The basal portion 22 is coupled to the floorboard 14 having the upright portion 24 extending away from the floorboard 14.

The upright portion 24 is hollow and the upright portion 24 has a first opening 26 extending into an interior of the upright portion 24. The upright portion 24 has a second opening 28 extending into the interior of the upright portion 24. The second opening 28 is directed toward the brake pedal 18 and the first opening 26 is directed toward the floorboard 14. A pulley 30 is rotatably coupled to the bracket 20 and the pulley 30 is positioned within the upright portion 24 of the bracket 20.

A handle 32 is movably positioned within the vehicle 16 and the handle 32 is directed toward a passenger seat of the vehicle 16. In this way the handle 32 is accessible to a passenger in the vehicle 16. The passenger may be a driver's education teacher, a parent teaching a child to drive or any other passenger that may need to remotely engage the brakes of the vehicle 16. The handle 32 has a stem 34 and a head 36 extending along an axis that is oriented perpendicular to the stem 34. The stem 34 has a distal end 38 with respect to the head 36 and the handle 32 is urgeable into a braking position.

A cable 40 is coupled between the handle 32 and the brake pedal 18 of the vehicle 16. The cable 40 draws the brake pedal 18 into a depressed position when the handle 32 is urged into the braking position. In this way the handle 32 facilitates the passenger to remotely apply the brakes of the vehicle 16. The cable 40 has a first end 42 and a second end 44. The first end 42 is coupled to the distal end 38 of the handle 32 and the second end 44 is coupled to the brake pedal 18. The cable 40 extends into the first opening 26 in the upright portion 24 of the bracket 20 and the cable 40 extends around the pulley 30. Additionally, the cable 40 extends outwardly through the second opening 28 in the upright portion 24.

The cable 40 may be a sheathed cable or the like and the cable 40 is routed along a strategic route in the vehicle 16 for hiding the cable 40. A plurality of cable retainers 46 is provided and each of the cable retainers 46 is coupled to the vehicle 16. The cable 40 extends through each of the cable retainers 46 to retain the cable 40 along the strategic route. The cable retainers 46 may be cable clamps, cable clips or any other type of retainer that is commonly used to attach a cable to a surface.

In use, the roller unit 12, the cable 40 and the handle 32 are retrofitted into a vehicle 16 that will be driven by a student driver. The passenger who is supervising the student driver can grab the handle 32 at any time to urge the handle 32 into the braking position. In this way the passenger can remotely engage the brakes of the vehicle 16 when the student driver is driving the vehicle 16 into a potentially dangerous situation. The roller unit 12, the cable 40 and the handle 32 can be removed from the vehicle 16 when the student driver has sufficient skill to drive unsupervised.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A remote braking assembly being configured to facilitate a passenger to remotely actuate brakes in a vehicle, said assembly comprising:
a roller unit being coupled to a floorboard of a vehicle, said roller unit being aligned with a brake pedal of the vehicle, said roller unit comprising
a bracket having a basal portion and an upright portion, said basal portion being coupled to the floorboard having said upright portion extending away from the floorboard, said upright portion being hollow, said upright portion having a first opening extending into an interior of said upright portion, said first opening being directed toward the floorboard, said upright portion having a second opening extending into said interior of said upright portion, said second opening being directed toward the brake pedal, and
a pulley being rotatably coupled to said bracket, said pulley being positioned within said upright portion of said bracket wherein said upright portion encloses said pulley within said bracket;
a handle being movably positioned within the vehicle, said handle being directed toward a passenger seat of the vehicle wherein said handle is configured to be accessible to a passenger in the vehicle, said handle being urgeable into a braking position; and
a cable being coupled between said handle and the brake pedal of the vehicle, said cable drawing the brake pedal into a depressed position when said handle is urged into said braking position wherein said handle is configured to facilitate the passenger to apply the brakes of the vehicle.

2. (canceled)

3. (canceled)

4. (canceled)

5. The assembly according to claim 1, wherein:
said handle has a stem and a head extending along an axis being oriented perpendicular to said stem, said stem having a distal end with respect to said head; and
said cable has a first end and a second end, said first end being coupled to said distal end of said handle, said second end being coupled to the brake pedal.

6. (canceled)

7. A remote braking assembly being configured to facilitate a passenger to remotely actuate brakes in a vehicle, said assembly comprising:
a roller unit being coupled to a floorboard of a vehicle, said roller unit being aligned with a brake pedal of the vehicle, said roller unit comprising:
a bracket having a basal portion and an upright portion, said basal portion being coupled to the floorboard having said upright portion extending away from the floorboard, said upright portion being hollow, said upright portion having a first opening extending into an interior of said upright portion, said upright portion having a second opening extending into said interior of said upright portion, said second opening being directed toward the brake pedal, said first opening being directed toward the floorboard;
a pulley being rotatably coupled to said bracket, said pulley being positioned within said upright portion of said bracket;
a handle being movably positioned within the vehicle, said handle being directed toward a passenger seat of the vehicle wherein said handle is configured to be accessible to a passenger in the vehicle, said handle having a stem and a head extending along an axis being oriented perpendicular to said stem, said stem having a distal end with respect to said head, said handle being urgeable into a braking position; and
a cable being coupled between said handle and the brake pedal of the vehicle, said cable drawing the brake pedal into a depressed position when said handle is urged into said braking position wherein said handle is configured to facilitate the passenger to apply the brakes of the vehicle, said cable having a first end and a second end, said first end being coupled to said distal end of said handle, said second end being coupled to the brake pedal, said cable extending into said first opening in said upright portion of said bracket, said cable extending around said pulley, said cable extending outwardly through said second opening in said upright portion, said cable being routed along a strategic route in the vehicle for hiding said cable.
